(19) United States
(12) Patent Application Publication
(10) Pub. No.: US 2019/0130405 A1
(43) Pub. Date: May 2, 2019

(54) DEVICE-HARDWARE-BASED TRUSTED APPLICATION SYSTEM

(71) Applicant: PAYPAL, INC., San Jose, CA (US)

(72) Inventors: Andrew Adams, San Jose, CA (US); Dishti Malhotra, San Jose, CA (US); Kaushik Ramnath Swaminathan, San Jose, CA (US)

(21) Appl. No.: 15/798,767

(22) Filed: Oct. 31, 2017

(51) Int. Cl. G06Q 20/40

(52) U.S. Cl. CPC G06Q 20/4016; G06Q 20/405

(57) ABSTRACT

A device-hardware-based trusted application system includes database(s) storing details of the use of a first application included on user device, in association with a user device hardware identifier unique to hardware in the user device and a user account identifier unique to a user account utilized with the first application. The system receives a second merchant application transaction that is associated with a second merchant application, and analyzes the second merchant application transaction using a first risk model to determine that the second merchant application transaction should be declined. In response, the system then retrieves the first user device hardware identifier and the user account identifier from the second merchant application transaction, and uses them to access the database and approve the second merchant application transaction based on the details of the use of the first application.

### BACKGROUND

### Field of the Disclosure

The present disclosure generally relates to online and/or mobile transactions, and more particularly to a system that provides for the trusting of a merchant application provided on a user device based on hardware in the user device running the merchant application and a user device history that details the use of other merchant applications on that user device.

### Related Art

More and more consumers are conducting electronic transactions over electronic networks such as, for example, the Internet. For example, consumers routinely purchase products and services from merchants and individuals alike. The transactions may take place directly between a conventional or on-line merchant or retailer and the consumer, and transaction typically includes entering credit card or other financial information. Transactions may also take place with the aid of an on-line or mobile service provider such as, for example, PayPal, Inc. of San Jose, Calif. Such service providers can make transactions easier and safer for the parties involved. Purchasing with the assistance of a service provider from the convenience of virtually anywhere using a mobile device is one main reason why on-line and mobile transactions are growing very quickly.

The prevalence of online and mobile transactions is growing quickly, and service providers have helped enable that growth by providing accounts to their users for use in performing those online and mobile transactions. In particular, the users may add their accounts (provided by the service provider) as funding options with merchant applications, and then conduct subsequent online and mobile transactions within or via those merchant applications using those accounts. However, in a variety of situations and for a variety of reasons, requests to add those accounts as funding options with merchant applications, and/or instructions to use of those accounts to facilitate online and mobile transactions within or via those merchant applications, may be declined by the service provider.

It has been found that even a single decline of a request to add an account as a funding option with a merchant application, or an instruction to use the mobile application to conduct a transaction with or via the merchant application, is accompanied by a substantial risk the associated user forgoing the use of the account with that merchant application, and instead using any of a variety of alternative funding options that may be available to them. Furthermore, in addition to affecting the loyalty of users to the service provider, users also tend to view the merchant application and/or merchant negatively when such issues arise with the use of their mobile application in the merchant application, and that can result in loss revenues for the merchant. It has been discovered that a significant number of declines associated with user accounts (e.g., the adding of that user account for use with a merchant application, the using of that account within or via the merchant application, etc.) are “false” declines that are based on a conventionally determined risk, and that could be approved without a resulting loss.

Thus, there is a need for improved systems for utilizing accounts with merchant applications for conducting electronic transactions.

### BRIEF DESCRIPTION OF THE FIGURES

FIG. 1 is a flow chart illustrating an embodiment of a method for device-hardware-based application trust;

FIG. 2A is a schematic view illustrating an embodiment of a user device;

FIG. 2B is a schematic view illustrating an embodiment of the user device of FIG. 2A displaying an account provider application;

FIG. 2C is a schematic view illustrating an embodiment of the user device of FIG. 2A displaying a rideshare application;

FIG. 2D is a schematic view illustrating an embodiment of the user device of FIG. 2A displaying a coffee shop application;

FIG. 3 is a schematic view illustrating an embodiment of a service provider device;

FIG. 4A is a schematic view illustrating an embodiment of the user device of FIG. 2A displaying a hotel application;

FIG. 4B is a schematic view illustrating an embodiment of the user device of FIG. 2A displaying the coffee shop application;

FIG. 5A is a schematic view illustrating an embodiment of the service provider device of FIG. 3 including a user transaction loss database;

FIG. 5B is a schematic view illustrating an embodiment of the service provider device of FIG. 3 including a user authentication flow database;

FIG. 5C is a schematic view illustrating an embodiment of the service provider device of FIG. 3 including a user behavior database;

FIG. 6 is a schematic view illustrating an embodiment of a networked system;

FIG. 7 is a perspective view illustrating an embodiment of a user device; and

FIG. 8 is a schematic view illustrating an embodiment of a computer system.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes systems and methods for device-hardware-based trust of applications and, in specific embodiments, details the utilization of device hardware identifiers to approve merchant-based application transactions that would otherwise be declined using conventional risk models. Those system and methods operate by receiving a current merchant application transaction from a user device that is generated by a second merchant application and, when the analysis of that current merchant application transaction indicates that a conventional risk model will result in a decline state for that current merchant application transaction, utilizing a device hardware identifier and an account identifier in that current merchant application transaction to access database(s) of user device application history information that details the previous use of first merchant application(s) included on user device in order to determine whether to approve or decline the current merchant application transaction generated by the second merchant application.

For example, if the user device application history information includes a single previous merchant application transaction that was generated by a first merchant application on the user device with a maximum time period (e.g., a month), and that single previous merchant application transaction did not result in a loss, the current merchant application transaction may be approved. If the user device application history information includes multiple previous merchant application transactions that were generated by first merchant application(s) on the user device and none of those previous merchant application transactions resulted in a loss, the current merchant application transaction may be approved. If the user device application history information identifies that an authentication flow was previously completed by first merchant application(s) on the user device, the current merchant application transaction may be approved. If the user device application history information includes behavior information that indicates the current merchant application transaction should be approved, the current merchant application transaction is approved. If none of these conditions are met, the current merchant application transaction may be denied. Experimental embodiments indicate that the systems and methods of the present disclosure can reduce the false or incorrect declining of merchant application transactions by a significant amount, thus providing a technical solution (device-hardware-identifier-based trust of merchant applications) to a problem that is specific to the online and/or mobile electronic transactions conducted over network, and advancing online/mobile device transaction technology.

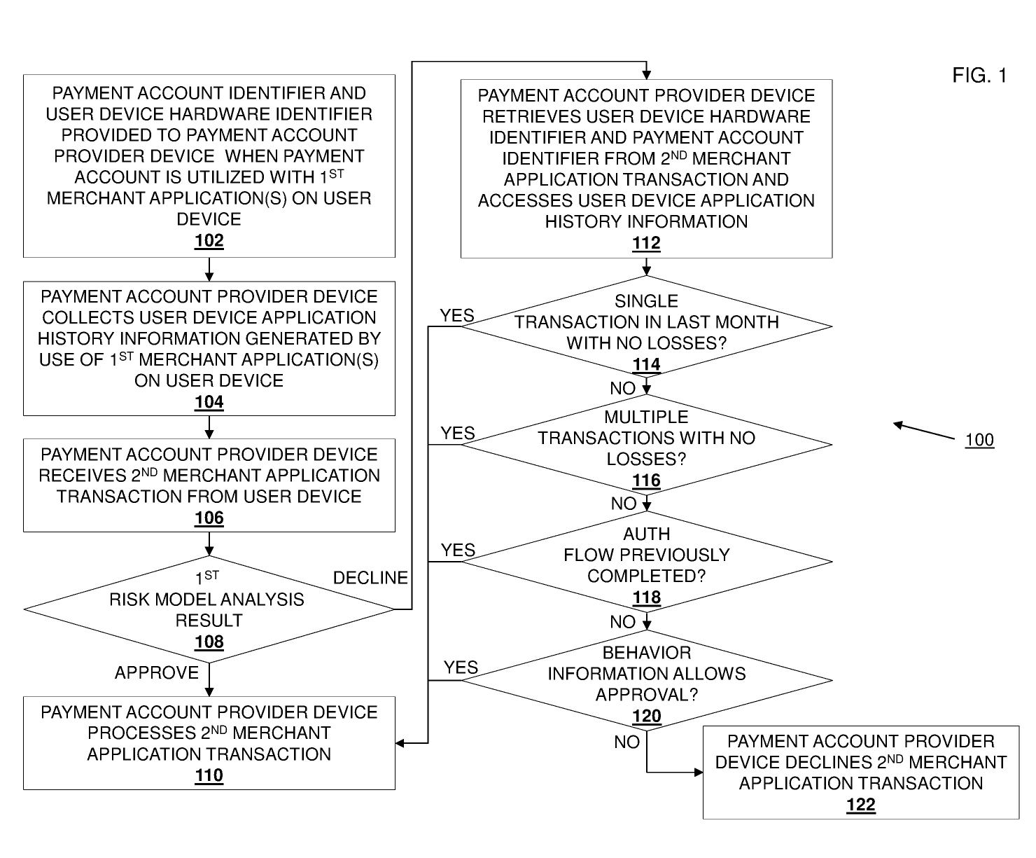

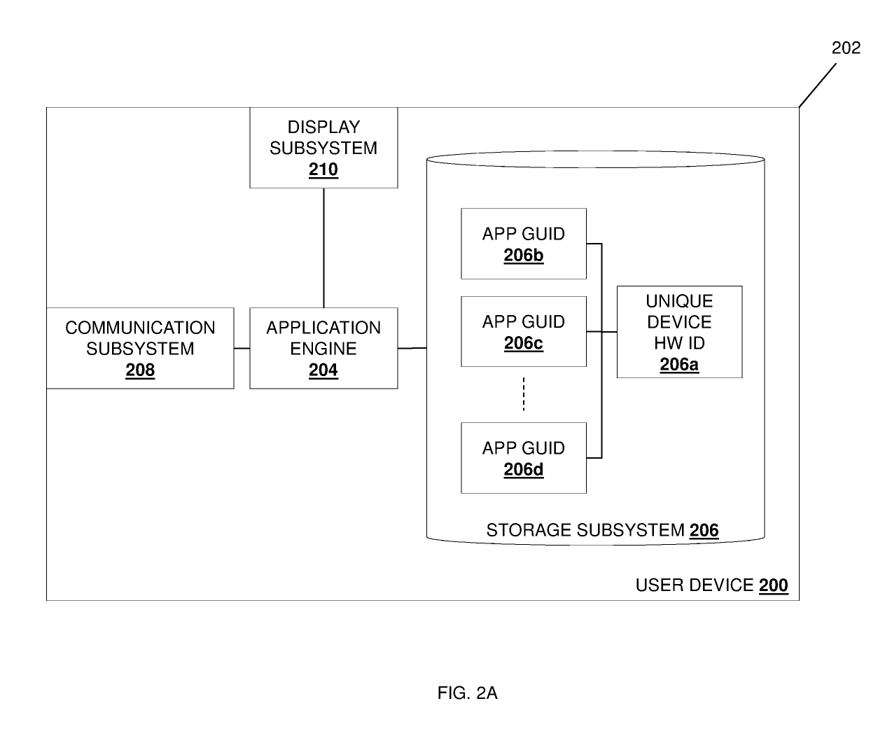

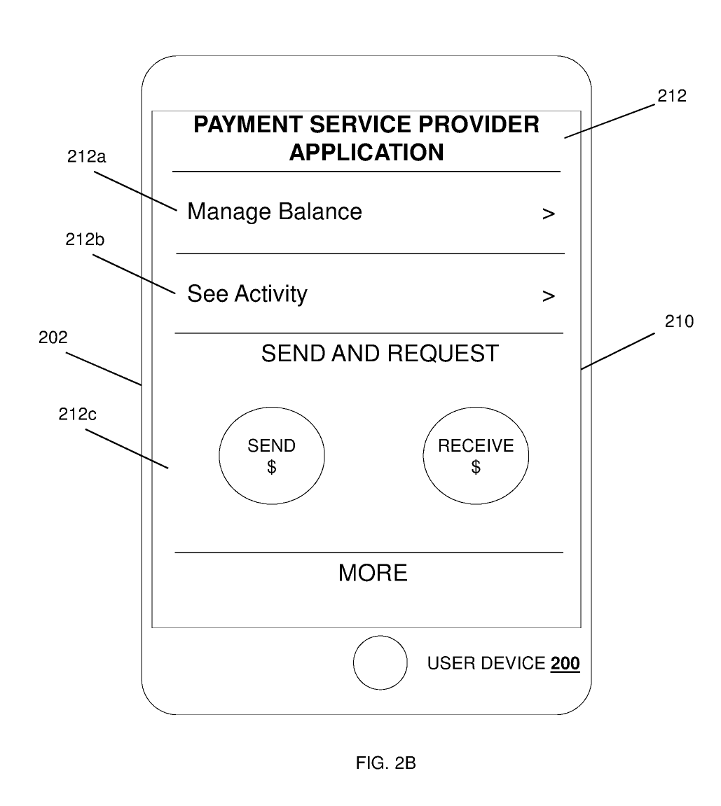

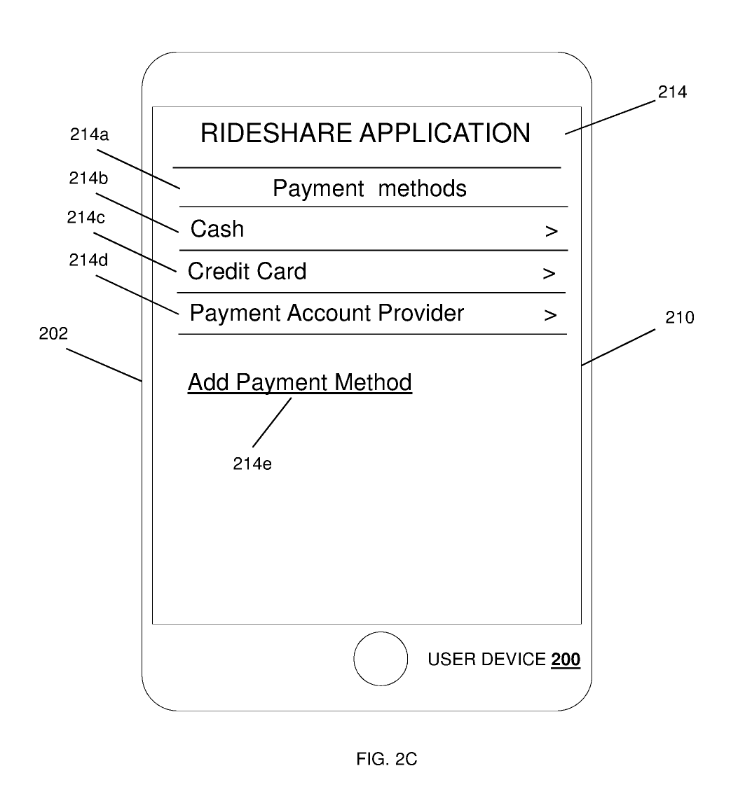

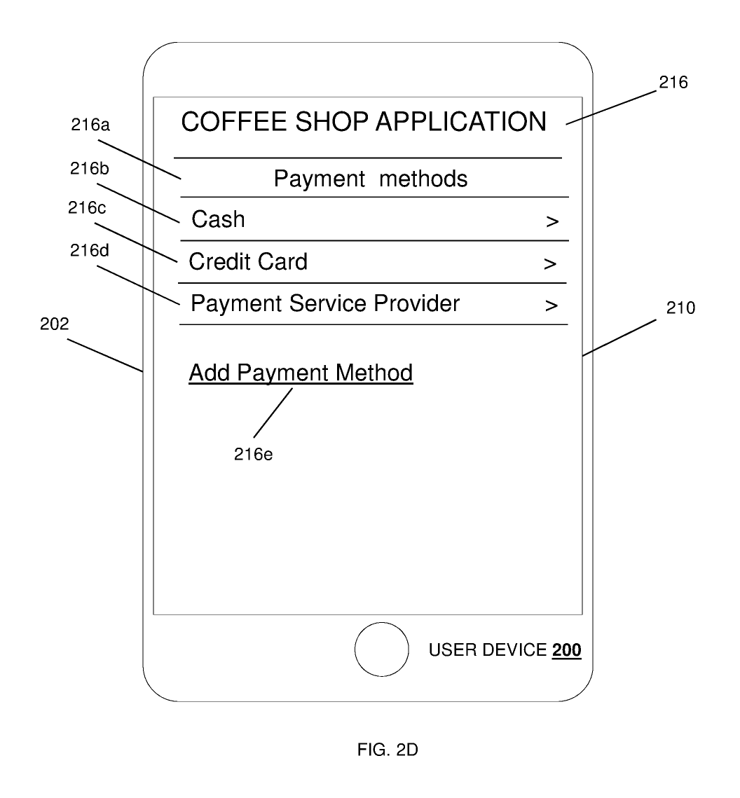

Referring now to FIGS. 1 and 2, a method 100 for device-hardware-based application trust is illustrated. The method 100 may begin at block 102 where an account identifier and user device hardware identifier are provided to an account provider device when an account is utilized with first merchant application(s) on the user device. Referring to FIG. 2A, an embodiment of a user device 200 is illustrated. In the illustrated embodiment, the user device 200 includes a chassis 202 that houses the components of the user device 200, only some of which are illustrated in FIG. 2A. For example, the chassis 200 may house one or more hardware processors (not illustrated) that are coupled to a non-transitory memory system (not illustrated) that includes instructions that, when executed by the one or more hardware processors, cause the one or more hardware processors to provide an application engine 204 that is configured to perform the functions of the application engines and/or user devices discussed below.

The chassis 202 may also house a storage subsystem 206 that is coupled to the application engine 204 (e.g., via a coupling between the one or more hardware processors and the storage subsystem 204) and that stores a unique device hardware identifier 206a that may, in the illustrated example, be associated with application global unique identifiers (GUIDs) 206b, 206c, and up to 206d. In an embodiment, the unique device hardware identifier 206a may include an International Mobile Equipment Identity (IMEI) number, a Mobile Equipment Identifier (MEID) number, an Electronic Serial Number (ESN), an International Mobile Subscriber Identity (IMSI) number, unique identifier numbers associated with the one or more hardware processors, the non-transitory memory system, the storage subsystem, and/or a variety of other unique device hardware identifiers that would be apparent to one of skill in the art in possession of the present disclosure. Furthermore, the application GUIDs 206b-d may identify an Application Programming Interface (API) utilized to create the merchant application. Further still, any or all of the unique device hardware identifier described above may be combined (e.g., hashed using a hashing algorithm) in order to derive a combined unique device hardware identifier while remaining within the scope of the present disclosure as well.

Furthermore, each of the application GUIDs 206b-d may be associated with a respective merchant application that is provided on the user device 200 (as discussed below). For example, each installation or other provisioning of a merchant application on the user device 200 may result in the generation of an associated application GUID for that merchant application, and the subsequent association of that application GUID with the unique device hardware identifier 206a in the storage subsystem 206 (as illustrated). As such, the user device 200 includes the unique device hardware identifier 206a that is associated with application GUIDs 206b-d that are unique to the merchant application that have been installed/provisioned on that user device 200, and thus actions performed using any particular merchant application on the user device 200 may identifiable as having been performed via that merchant application and on that user device 200 as along as the associated application GUID and unique device hardware identifier are provided with that action.

The chassis 202 may also house a communication subsystem 208 that is coupled to the application engine 204 (e.g., via a coupling between the one or more hardware processors and the communication subsystem 208) and that may include a Network Interface Controller (NIC), a wireless communication device (e.g., a cellular communication device, a Bluetooth communication device, a Near Field Communication (NFC) device, etc.), and/or a variety of other communication components known in the art. The chassis 202 may also house a display subsystem 210 that is coupled to the application engine 204 (e.g., via a coupling between the one or more hardware processors and the display subsystem 210) and that may include a touch-input display screen and/or other display components known in the art. While a specific user device 200 has been illustrated and described in FIG. 2A, and that discussed below in a manner that one of skill in the art will recognize as a mobile phone, one of skill in the art in possession of the present disclosure will appreciate that other types of user devices (e.g., tablet computing devices, laptop/notebook computing devices, desktop computing devices, etc.) may fall within the scope of the present disclosure as well.

With reference to FIG. 2B, the user device 200 is illustrated displaying an account provider application 212 on the display subsystem 210. In some embodiments, the account provider application 212 may be provided by a service provider (discussed below) such as, for example, PAYPAL® Inc. of San Jose, Calif., United States. As such, the service provider may operate to provide accounts to users and may allow the users to link financial accounts provided by financial account providers (e.g., checking accounts, savings accounts, credit accounts, etc.) with those accounts, which enables funding of the accounts for use in performing transactions. Thus, the payment account provider application 212 may be provided on the user device 200 to allow the user to access the account provided by the account provider, allow the user to link financial accounts to that account, allow the user to fund that account, allow the user to perform transactions using that account, and/or allow the user to perform any other account functionality that would be apparent to one of skill in the art in possession of the present disclosure. However, one of skill in the art in possession of the present disclosure will appreciate that the service provider may be replaced by a variety of account providers while remaining within the scope of the present disclosure.

In the example provided in FIG. 2B, the account provider application 212 includes a manage balance section 212a that the user may select in order to manage a funds balance for the account, a see activity section 212b that the user may select in order to view past activity associated with the account, and a transaction section 212c that the user may utilize to perform transactions such as, for example, sending funds to another user (e.g., via a “SEND” payment button) and receiving funds from another user (e.g., via a “RECEIVE” payment button). However, while a specific screen provided on the account provider application 212 is illustrated in FIG. 2B, one of skill in the art in possession of the present disclosure will appreciate that account provider applications may provide other screens and/or functionality while remaining within the scope of the present disclosure as well.

In some embodiments of block 102, an account identifier and user device hardware identifier may be provided to account provider device when the account provider application 212 is provided on the user device 200. For example, the user of the user device 200 may install or otherwise provide the account provider application 212 on the user device 200, and then use of the account provider application 212 to sign up or otherwise register for an account provided by the account provider via the account provider application 212, or provide credentials to the account provider application 212 in order to access an account that the user has previously registered for with the account provider. In an embodiment, the accessing of the account via the account provider application 212 on the user device 202 may result in the account provider application 212 retrieving the user device hardware identifier 206a from the storage subsystem 206, and providing that user device hardware identifier 206a, along with an account identifier associated with the account that the user is accessing via the account provider application 212, through the network to an account provider device operated by the account provider (e.g., the account provider device 300 discussed below). As such, at block 102, the account provider device may receive the account identifier and user device hardware identifier upon an initial installation of the account provider application 212 on the user device 200, and/or any subsequent use of the account provider application 212 on the user device 200.

With reference to FIG. 2C, the user device 200 is illustrated displaying a rideshare application 214 on the display subsystem 210. In some embodiments, the rideshare application 214 is a merchant application that may be provided by a rideshare merchant such as, for example, UBER® of San Francisco, Calif., United States; LYFT® of San Francisco, Calif., United States; or CAR2GO® of Stuttgart, Germany. As such, the rideshare merchant may operate to provide rideshare services to users and may allow the users to link the account provided by the account provider to a rideshare account provided by the rideshare merchant, which enables the transaction by the user for rideshare services provided by the rideshare merchant using the account. Thus, the rideshare application 214 may be provided on the user device 200 to allow the user to order rideshare services, conduct transactions to use rideshare services, and/or perform any other rideshare service functionality that would be apparent to one of skill in the art in possession of the present disclosure. In an embodiment, the rideshare application 214 may be created by the rideshare merchant using a mobile user device Software Development Kit (SDK) that is provided by the account provider and that enables the rideshare application to perform the functionality discussed below (including the generation of the second merchant application transactions that include the information utilized by the account provider to enable the functionality discussed below). Furthermore, the account provider device of the account provider may include a backend system that integrates the functionality enabled by the mobile user device SDK to enable the method 100 as discussed below.

In the example provided in FIG. 2C, the rideshare application 214 includes a payment methods section 214a that lists methods that the user has enabled with the rideshare application 214 in order to allow for payment of rideshare services, with a cash selector 214b that the user may select in access a cash payment method, a credit selector 214c that the user may select in access a credit payment method, a payment account provider selector 214c that the user may select in order to access a payment account provider method, and an add payment method selector 214e that the user may select to enable other payment methods with the rideshare application 214. However, while a specific screen provided on the rideshare application 214 is illustrated in FIG. 2C, one of skill in the art in possession of the present disclosure will appreciate that rideshare applications may provide other screens and/or functionality while remaining within the scope of the present disclosure as well.

In some embodiments of block 102, the account identifier and user device hardware identifier are provided to account provider device when the account is utilized with the rideshare application 214 provided on the user device 202. For example, the user of the user device 200 may add the account provided by the account provider as a payment method for use with the rideshare application 214 on the user device 200 (e.g., via the add payment method selector 214a and associated screens on the rideshare application 214, not illustrated), and/or use that account to make a payment for rideshare services provided via the rideshare application 214 on the user device 200 (e.g., automatically via the rideshare application 214, or via screens on the rideshare application 214, not illustrated).

In an embodiment, the adding of the payment account as a payment method for the rideshare application 214 on the user device 202 may result in the rideshare application 212 retrieving the user device hardware identifier 206a from the storage subsystem 206, and providing that user device hardware identifier 206a, an application GUID (e.g., the application GUID 206b in this example) that is associated with the rideshare application 214, and the account identifier for the account that has been enabled as the payment method with the rideshare application 214, through the network to the account provider device operated by the account provider. Similarly, the use of the account as a payment method to pay for rideshare services via the rideshare application 214 on the user device 202 may result in the rideshare application 214 retrieving the user device hardware identifier 206a from the storage subsystem 206, and providing that user device hardware identifier 206a, an application GUID (e.g., the application GUID 206b in this example) that is associated with the rideshare application 214, and the account identifier for the account that is being used as the payment method for the rideshare application 214, through the network to the account provider device operated by the account provider. As such, at block 102, the account provider device may receive the user device hardware identifier upon enablement of the account with the rideshare application 214 on the user device 202, and/or subsequent use of the payment account to pay for rideshare services via the rideshare application 214.

With reference to FIG. 2D, the user device 200 is illustrated displaying a coffee shop application 216 on the display subsystem 210. In some embodiments, the coffee shop application 216 is a merchant application that may be provided by a coffee shop merchant such as, for example, STARBUCKS® Corporation of Seattle, Wash., United States; PEET'S COFFEE® of Berkeley, Calif., United States; or DUNKIN′ DONUTS® of Canton, Mass., United States. As such, the coffee shop merchant may operate to provide coffee shop products and services to users, and may allow the users to link the account provided by the account provider to a coffee shop account provided by the coffee shop merchant, which enables the payment for coffee shop products and services provided by the coffee shop merchant using the account. Thus, the coffee shop application 216 may be provided on the user device 200 to allow the user to view coffee shop products and services, order coffee shop products and services, make payments for coffee shop products and services, and/or to perform any other coffee shop product and service functionality that would be apparent to one of skill in the art in possession of the present disclosure. In an embodiment, the coffee shop application 216 may be created by the rideshare merchant using a mobile user device Software Development Kit (SDK) that is provided by the account provider and that enables the coffee shop application to perform the functionality discussed below (including the generation of the second merchant application transactions that include the information utilized by the account provider to enable the functionality discussed below). Furthermore, the account provider device of the account provider may include a backend system that integrates the functionality enabled by the mobile user device SDK to enable the method 100 as discussed below.

In the example provided in FIG. 2D, the coffee shop application 216 includes a payment methods section 216a that lists payment methods that the user has enabled with the coffee shop application 216 in order to allow for payment of coffee shop products and services, with a cash selector 216b that the user may select in access a cash payment method, a credit selector 216c that the user may select in access a credit payment method, a payment account provider selector 216c that the user may select in order to access a payment account provider method, and an add payment method selector 216e that the user may select to enable other payment methods with the coffee shop application 216. However, while a specific screen provided on the coffee shop application 216 is illustrated in FIG. 2D, one of skill in the art in possession of the present disclosure will appreciate that coffee shop applications may provide other screens and/or functionality while remaining within the scope of the present disclosure as well.

In some embodiments of block 102, the account identifier and user device hardware identifier are provided to account provider device when the account is utilized with the coffee shop application 216 provided on the user device 202. For example, the user of the user device 200 may add the payment account provided by the account provider as a payment method for use with the coffee shop application 216 on the user device 200 (e.g., via the add payment method selector 216a and associated screens on the coffee shop application 216, not illustrated), and/or use that account to make a payment for coffee shop products and services via the coffee shop application 216 on the user device 200 (e.g., automatically via the coffee shop application 216, or via payment screens on the coffee shop application 216, not illustrated).

In an embodiment, the adding of the account as a payment method for the coffee shop application 216 on the user device 202 may result in the coffee shop application 212 retrieving the user device hardware identifier 206a from the storage subsystem 206, and providing that user device hardware identifier 206a, an application GUID (e.g., the application GUID 206c in this example) that is associated with the coffee shop application 216, and the payment account identifier for the payment account that has been enabled as the payment method for the coffee shop application 216, through the network to the account provider device operated by the account provider. Similarly, the use of the account as a payment method to pay for coffee shop products and services via the coffee shop application 216 on the user device 202 may result in the coffee shop application 216 retrieving the user device hardware identifier 206a from the storage subsystem 206, and providing that user device hardware identifier 206a, an application GUID (e.g., the application GUID 206c in this example) that is associated with the coffee shop application 216, and the account identifier for the payment account that is being used as the payment method for the coffee shop application 216, through the network to the account provider device operated by the account provider. As such, at block 102, the account provider device may receive the user device hardware identifier upon enablement of the account with the coffee shop application 216 on the user device 202, and/or subsequent use of the account to pay for coffee shop products and services via the coffee shop application 216.

While a few examples of specific merchant applications provided on the user device 200 have been provided, one of skill in the art in possession of the present disclosure will recognize that the account provider application provided by the account provider may be enabled as a payment method with any merchant application provided on the user device, and used to make payments via those merchant applications, while remaining within the scope of the present disclosure. Furthermore, any of those uses of the account may result in the user device hardware identifier 206a being provided along with the account identifier to the account provider device of the account provider.

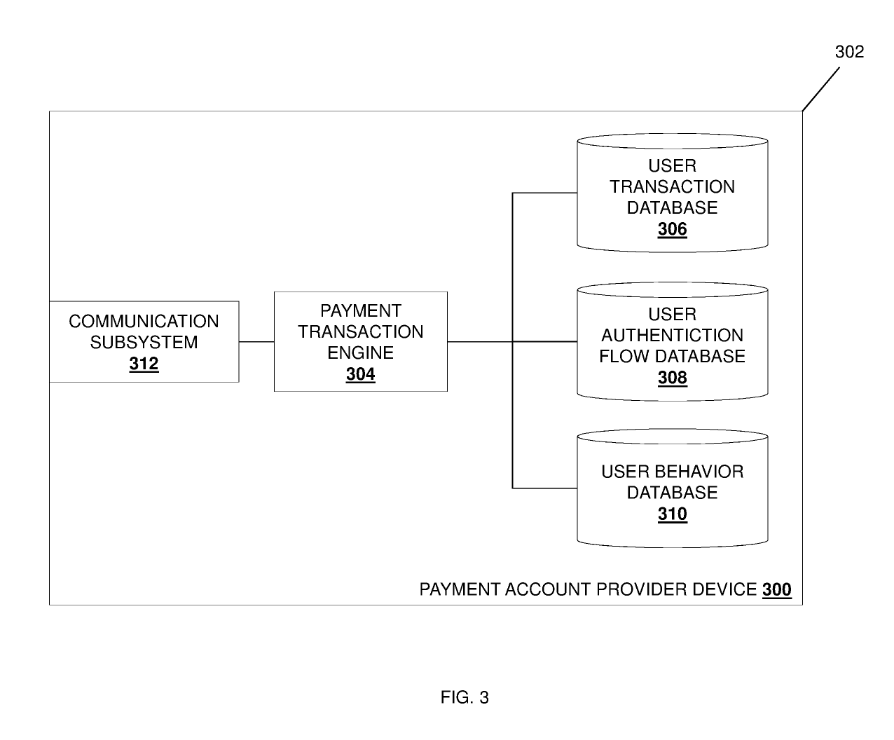

The method 100 then proceeds to block 104 where the account provider device collects user device application history information generated by the use of the first merchant application(s) on the user device. Referring to FIG. 3, an embodiment of an account provider device 300 is illustrated. In the illustrated embodiment, the payment account provider device 300 includes a chassis 302 that houses the components of the account provider device 300, only some of which are illustrated in FIG. 3. For example, the chassis 300 may house one or more hardware processors (not illustrated) that are coupled to a non-transitory memory system (not illustrated) that includes instructions that, when executed by the one or more hardware processors, cause the one or more hardware processors to provide a payment transaction engine 304 that is configured to perform the functions of the transaction engines and/or account provider devices discussed below.

The chassis 602 may also house a storage subsystem (not illustrated) that is coupled to the transaction engine 304 (e.g., via a coupling between the one or more hardware processors and the storage subsystem), and that includes a user transaction database 306 that may be used to store information about transactions performed by users using their accounts (e.g., in association with merchant applications), a user authentication flow database 308 that may be used to store information about authentication flows conducted in order to authorize users to utilize their accounts (e.g., in association with merchant applications), and a user behavior database 310 that may be used to store information about user behaviors with their accounts (e.g., in association with merchant applications).

The chassis 302 may also house a communication subsystem 312 that is coupled to the transaction engine 304 (e.g., via a coupling between the one or more hardware processors and the communication subsystem 312) and that may include a Network Interface Controller (NIC), a wireless communication device (e.g., a cellular communication device, a Bluetooth communication device, a Near Field Communication (NFC) device, etc.), and/or a variety of other communication components known in the art. While a specific account provider device 300 has been illustrated and described in FIG. 3, one of skill in the art in possession of the present disclosure will appreciate that other types of account provider devices and/or device components may fall within the scope of the present disclosure as well.

In an embodiment, at block 104, the transaction engine 304 in the account provider device 300 collects user device application history information generated by the use of first merchant application(s) on the user device 300. For example, the account provider device 300 may identify the use of any account provided to a user via their user device using the account identifier associated with that account, and a unique user device hardware identifier that may be transmitted by a merchant application as a result of that use, as discussed above. For example, the account provider device may receive the account identifier and user device hardware identifier upon a use of the account with account provider application 212 on the user device 202 in a transaction and, in response, store any details of that transaction as user device application history information in the user transaction database 306 (and in association with the combination of that account identifier and user device hardware identifier). As such, “positive” results of that transaction such as positive reviews from the other party in the transaction, a lack of disputes about that transaction, etc.; or “negative” results of that transaction such as negative reviews from the other party in the transaction, a dispute about that transaction, etc.; may be stored in the user transaction database 306 at block 104.

Furthermore, the enablement of the account provide application 212 and/or its use in a transaction may be accompanied in some situations by an authentication flow in which the user is required to verify their identity or otherwise authenticate the use of the account provider application 212, and the transaction engine 304 in the account provider device 300 may store any details of such authentication flows in the user authentication flow database 308 at block 104. For example, such authentication flows may include a two-factor authentication flow, a secret answer authentication flow (e.g., where the user must answer a question only they would know the answer to, etc.). As such, “positive” results of those authentication flows such as a completion of the authentication flow, or “negative” results of those authentication flows such as a failure to complete the authentication flow, may be stored in the user authentication flow database 308 at block 104.

Further still, the transaction engine 304 in the payment account provider device 300 may store any details of user behavior with respect to the use of the account provide application 212 in the user behavior database 310. As such, purchasing behaviors, repayment behaviors, transaction activity behaviors, accounting linking behaviors, Internet Protocol (IP) address behaviors, application identifier behaviors, and/or other user behavior information may be stored in the user behavior database 310 at block 104.

In another example, the account provider device may receive the account identifier and user device hardware identifier upon a enablement of the account as a payment option with the rideshare application 214 on the user device 202 and, in response, store any details of that enablement as user device application history information in the user transaction database 306 and in association with the combination of that account identifier and user device hardware identifier. As such, “positive” results of that enablement such as a completed enablement of the account with the rideshare application 214, or “negative” results of that enablement such as a failure to enable the account with the rideshare application 214 may be stored in the user transaction database 306 at block 104.

In yet another example, the account provider device may receive the account identifier and user device hardware identifier in response to the use of the account in a payment transaction with the rideshare application 214 on the user device 202 and, in response, store any details of that transaction as user device application history information in the user transaction database 306 at block 104 and in association with the combination of that account identifier and user device hardware identifier. As such, “positive” results of that transaction such as positive reviews from the other party in the transaction, a lack of disputes about that transaction, etc.; or “negative” results of that transaction such as negative reviews from the other party in the transaction, a dispute about that transaction, etc.; may be stored in the user transaction database 306 at block 104.

Furthermore, the enablement of the rideshare application 214 and/or its use in a transaction may be accompanied in some situations by an authentication flow in which the user is required to verify their identity or otherwise authenticate the use of the rideshare application 214, and the transaction engine 304 in the account provider device 300 may store any details of such authentication flows in the user authentication flow database 308 at block 104. As such, “positive” results of those authentication flows such as a completion of the authentication flow, or “negative” results of those authentication flows such as a failure to complete the authentication flow, may be stored in the user authentication flow database 308 at block 104. Further still, the transaction engine 304 in the payment account provider device 300 may store any details of user behavior with respect to the use of the rideshare application 214 in the user behavior database 310. As such, purchasing behaviors, repayment behaviors, transaction activity behaviors, accounting linking behaviors, Internet Protocol (IP) address behaviors, application identifier behaviors, and/or other user behavior information may be stored in the user behavior database 310 at block 104.

In another example, the account provider device may receive the account identifier and user device hardware identifier upon a enablement of the account as a payment option with the coffee shop application 216 on the user device 202 and, in response, store any details of that enablement as user device application history information in the user transaction database 306 and in association with the combination of that account identifier and user device hardware identifier. As such, “positive” results of that enablement such as a completed enablement of the account with the coffee shop application 216, or “negative” results of that enablement such as a failure to enable the account with the coffee shop application 21b may be stored in the user transaction database 306 at block 104.

In yet another example, the account provider device may receive the account identifier and user device hardware identifier in response to the use of the account in a payment transaction with the coffee shop application 216 on the user device 202 and, in response, store any details of that payment transaction as user device application history information in the user transaction database 306 at block 104 and in association with the combination of that account identifier and user device hardware identifier. As such, “positive” results of that transaction such as positive reviews from the other party in the transaction, a lack of disputes about that transaction, etc.; or “negative” results of that transaction such as negative reviews from the other party in the transaction, a dispute about that transaction, etc.; may be stored in the user transaction database 306 at block 104.

Furthermore, the enablement of the coffee shop application 214 and/or its use in a transaction may be accompanied in some situations by an authentication flow in which the user is required to verify their identity or otherwise authenticate the use of the coffee shop application 214, and the transaction engine 304 in the account provider device 300 may store any details of such authentication flows in the user authentication flow database 308 at block 104. As such, “positive” results of those authentication flows such as a completion of the authentication flow, or “negative” results of those authentication flows such as a failure to complete the authentication flow, may be stored in the user authentication flow database 308 at block 104. Further still, the transaction engine 304 in the payment account provider device 300 may store any details of user behavior with respect to the use of the coffee shop application 216 in the user behavior database 310. As such, purchasing behaviors, repayment behaviors, transaction activity behaviors, accounting linking behaviors, Internet Protocol (IP) address behaviors, application identifier behaviors, and/or other user behavior information may be stored in the user behavior database 310 at block 104.

The method 100 then proceeds to block 106 where the account provider device receives a second merchant application transaction from the user device. In different embodiments, at block 106, the user device 200 may attempt to enable the account as a payment option with a second merchant application provided on the user device 200 (e.g., a second merchant application that has just been installed on the user device 200), or may attempt to use the account to perform a transaction via the second merchant application on the user device 200 and, in response, the second merchant application may send an associated second merchant application transaction through the network to the payment account provider device 300.

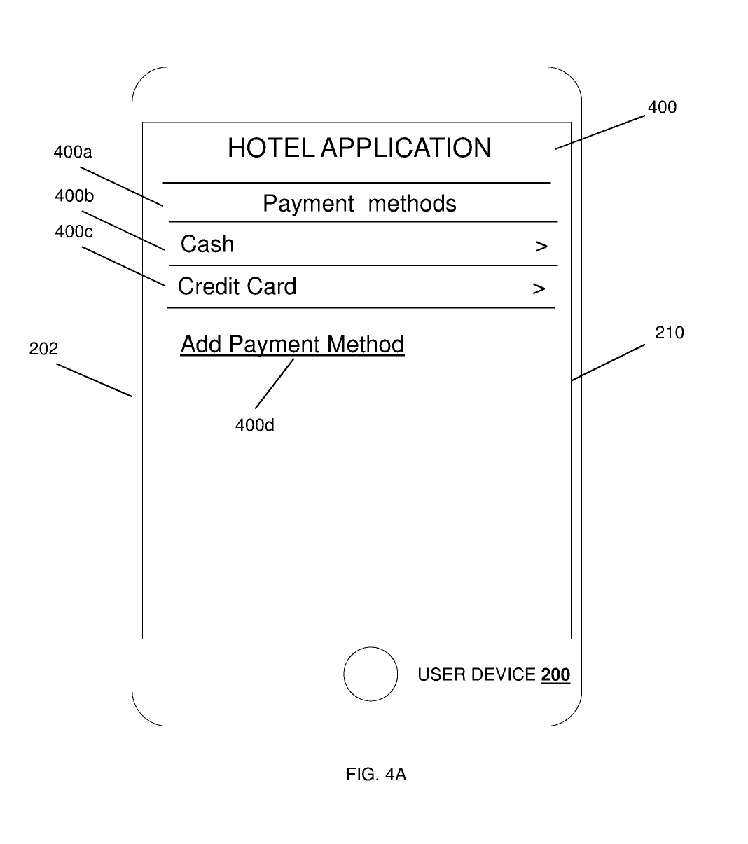

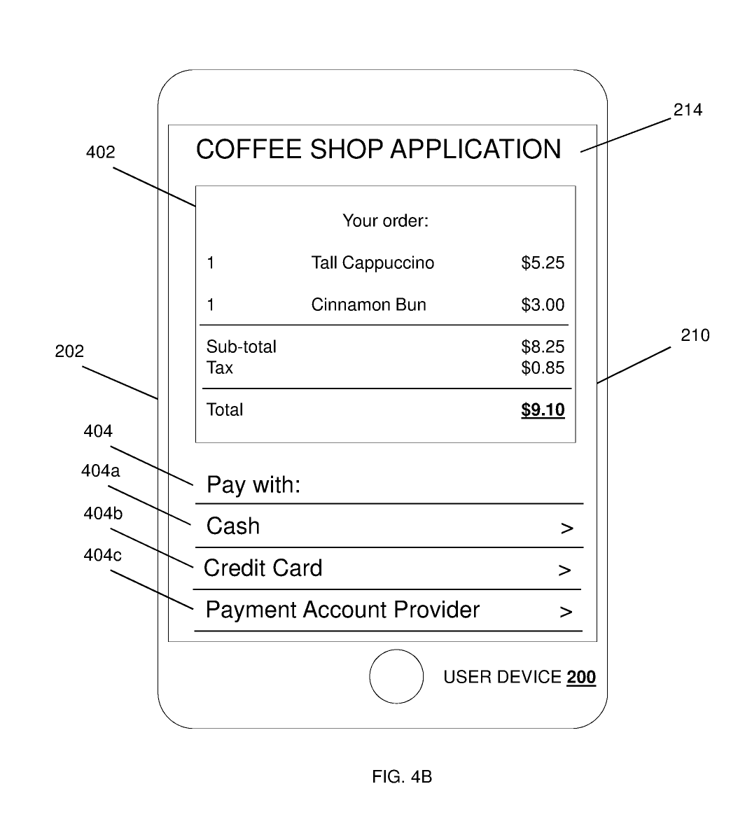

Referring now to FIG. 4A, the user device 200 is illustrated displaying a hotel application 400 on the display subsystem 210. In the illustrated example, the user of the user device 200 has just installed the hotel application 400 on the user device 200, and is attempting to enable the account provided by the account provider as a payment option for use with the hotel application. In some embodiments, the hotel application 400 is a merchant application that may be provided by a hotel merchant such as, for example, AIRBNB® Inc. of San Francisco, Calif., United States; HOTEL TONIGHT® of San Francisco, Calif., United States; or HOMEAWAY® Inc. of Austin, Tex., United States. As such, the hotel merchant may operate to provide hotel services to users and may allow the users to link the account provided by the account provider to a hotel account provided by the hotel merchant, which enables the payment for hotel services provided by the hotel merchant using the account. Thus, the hotel application 400 may be provided on the user device 200 to allow the user to reserve hotel services, make payments for hotel services, and/or allow the user to perform any other hotel service functionality that would be apparent to one of skill in the art in possession of the present disclosure. In an embodiment, the hotel application 400 may be created by the rideshare merchant using a mobile user device Software Development Kit (SDK) that is provided by the account provider and that enables the hotel application to perform the functionality discussed below (including the generation of the second merchant application transactions that include the information utilized by the account provider to enable the functionality discussed below). Furthermore, the account provider device of the account provider may include a backend system that integrates the functionality enabled by the mobile user device SDK to enable the method 100 as discussed below.

In the example provided in FIG. 4A, the hotel application 400 includes a payment methods section 400a that lists payment methods that the user has enabled with the hotel application 400 in order to allow for payment for hotel services, with a cash selector 400b that the user may select in order to access a cash payment method, and a credit selector 400c that the user may select in order to access a credit payment method, along with an add payment method selector 400d that the user may select to enable other payment methods with the hotel application 400. However, while a specific screen provided on the hotel application 400 is illustrated in FIG. 4A, one of skill in the art in possession of the present disclosure will appreciate that hotel applications may provide other screens and/or functionality while remaining within the scope of the present disclosure as well.

In some embodiments of block 106, the second merchant application transaction is provided to payment account provider device 300 when the user of the user device 200 attempts to add the account provided by the account provider as a payment method for use with the hotel application 400 on the user device 200 (e.g., via the add payment method selector 400d and associated screens on the hotel application 400, not illustrated). As discussed in further detail below, the adding of the account as a payment method for the hotel application 400 on the user device 202 may result in the hotel application 400 retrieving the user device hardware identifier 206a from the storage subsystem 206, and providing that user device hardware identifier 206a, an application GUID (e.g., the application GUID 206d in this example) that is associated with the hotel application 400, and the account identifier for the account that the user is attempting to enable as a payment method for the hotel application 400, as part of the second merchant application transaction through the network to a account provider device 300.

Referring now to FIG. 4B, the user device 200 is illustrated displaying the coffee shop application 300 on the display subsystem 210. In the illustrated example, the user of the user device 200 has installed the coffee shop application 400 on the user device 200 and previously enabled the account provided by the account provider as a payment option for use with the coffee shop application 214, and is now attempting to use the account in a transaction conducted via the coffee shop application 214.

In the example provided in FIG. 4B, the coffee shop application 214 includes a payment details section 402 that lists the details of products the user is purchasing via the coffee shop application 214, along with a payment method section 404 that includes a cash selector 404a that the user may select to utilize a cash method to pay for the products, a credit selector 404b that the user may select to utilize a credit method to pay for the products, and a payment account provider method selector 404c that the user may select to utilize the account provided by the account provider in order to pay for the products. However, while a specific screen provided on the coffee shop application 214 is illustrated in FIG. 4B, one of skill in the art in possession of the present disclosure will appreciate that coffee shop applications may provide other screens and/or functionality while remaining within the scope of the present disclosure as well.

In some embodiments of block 106, the second merchant application transaction is provided to account provider device 300 when the user of the user device 200 selects the account provider selector 404c and attempts to use the account provided by the account provider to pay for the products identified in the product details section 402 of the coffee shop application 214 displayed on the user device 200. As discussed in further detail below, the use of the account in a transaction via the coffee shop application 214 on the user device 202 may result in the hotel application 400 retrieving the user device hardware identifier 206a from the storage subsystem 206, and providing that user device hardware identifier 206a, an application GUID (e.g., the application GUID 206c in this example) that is associated with the coffee shop application 214, and the account identifier for the account that the user is attempting to utilized in the payment transaction via the coffee shop application 214, as part of the second merchant application transaction through the network to an account provider device 300.

The method 100 then proceeds to decision block 108 where the account provider device determines a first risk model analysis result for the second merchant application transaction. In an embodiment, at decision block 108, the transaction engine 304 in the account provider device 300 analyzes the second merchant application transaction using a conventional risk model and determined whether the second merchant application transaction should be approved or denied. In an embodiment, the conventional risk model analysis may include utilizing risk models to score each transaction based on a number of input variables such as Merchant type, User time on file, funding methods used, IP address, application identifier for the transaction, etc., in order to create a risk score for each transaction, and/or a variety of other risk model analysis actions known in the art. In such embodiments, the higher the risk score, the riskier the transaction, and that risk score can be incorporated into risk strategies to determine whether to decline transactions.

If, at decision block 108, it is determined that the first risk model analysis result indicates that the second merchant application transaction should be approved, the method 100 then proceeds to block 110 where the account provider device processes the second merchant application transaction. In an embodiment, at block 110, the transaction engine 304 in the account provider device 300 may determine that the conventional risk model analysis indicates that the account should be enabled as a payment option for the second merchant application and, in response, enable the payment account such that the account may be utilized to perform future payment transactions via the merchant application. As such, with reference to FIG. 4A, the account may be enabled as a payment option for further purchases made via the hotel application 400. In another embodiment, at block 110, the transaction engine 304 in the account provider device 300 may determine that the conventional risk model analysis indicates that a transaction using the payment account via the second merchant application should be approved and, in response, approve the payment transaction using the account via the second merchant application in order to pay for products and/or services. As such, with reference to FIG. 4B, a transaction via the coffee shop application 214 using the account may be approved in order to allow the user to purchase products and/or services provided by the coffee shop merchant.

If, at decision block 108, it is determined that the first risk model analysis result indicates that the second merchant application transaction should be declined, the method 100 then proceeds to block 112 where the account provider device retrieves a user device hardware identifier and an account identifier from the second merchant application transaction and uses the user device hardware identifier and the account identifier to access user device application history information. In an embodiment, at block 108, the payment transaction engine 304 in the account provider device 300 may determine that the conventional risk model analysis indicates that the account should not be enabled as a payment option for the second merchant application and, in response, the method 100 proceeds to block 112 where the account provider device 300 retrieves the user device hardware identifier and the account identifier from the second merchant application transaction provided by the second merchant application on the user device 200, and uses that user device hardware identifier and the account identifier to access user device application history information. As such, with reference to FIG. 4A, the transaction engine 304 in the account provider device 300 may determine at block 108 that the account should not be enabled as a payment option with the hotel application 400 as per the conventional risk model analysis, and may then retrieve the user device hardware identifier and the account identifier from the second merchant application transaction provided by the hotel application 400 at block 112, and use that user device hardware identifier and the account identifier to access user device application history information.

In another embodiment, at block 108, the transaction engine 304 in the account provider device 300 may determine that the conventional risk model analysis indicates that the transaction using the account via the second merchant application should not be approved and, in response, the method 100 proceeds to block 112 where the transaction engine 304 in the account provider device 300 retrieves the user device hardware identifier and the account identifier from the second merchant application transaction provided by the second merchant application on the user device 200, and uses that user device hardware identifier and the account identifier to access user device application history information. As such, with reference to FIG. 4B, the transaction engine 304 in the account provider device 300 may determine at block 108 that the transaction via the coffee shop application 214 using the payment account should not be approved, and may retrieve the user device hardware identifier and the payment account identifier from the second merchant application transaction provided by the coffee shop application 214 at block 112, and use that user device hardware identifier and the payment account identifier to access user device application history information.

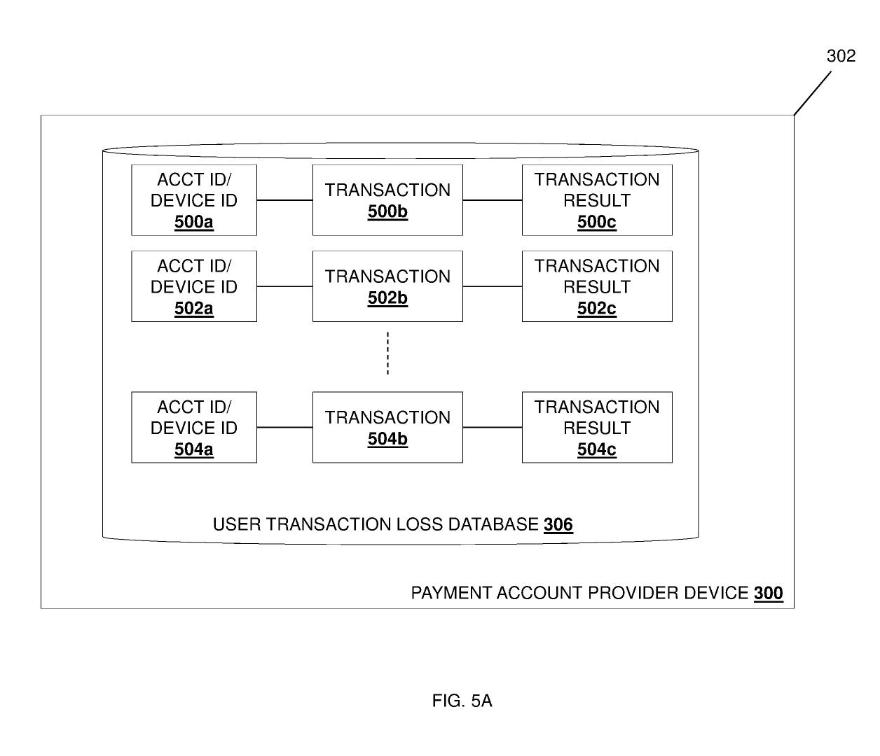

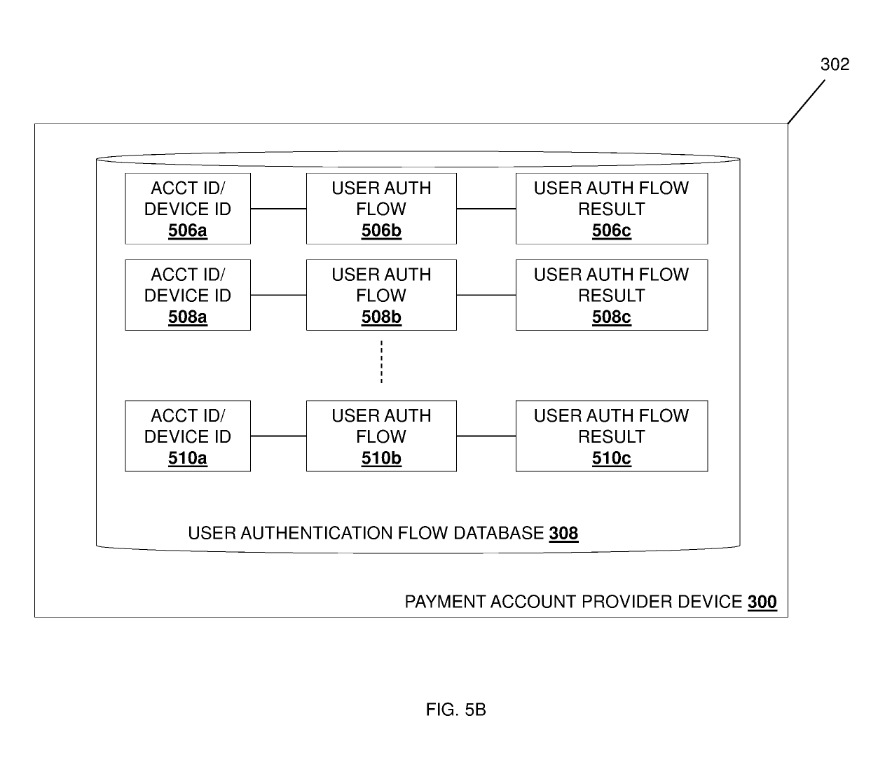

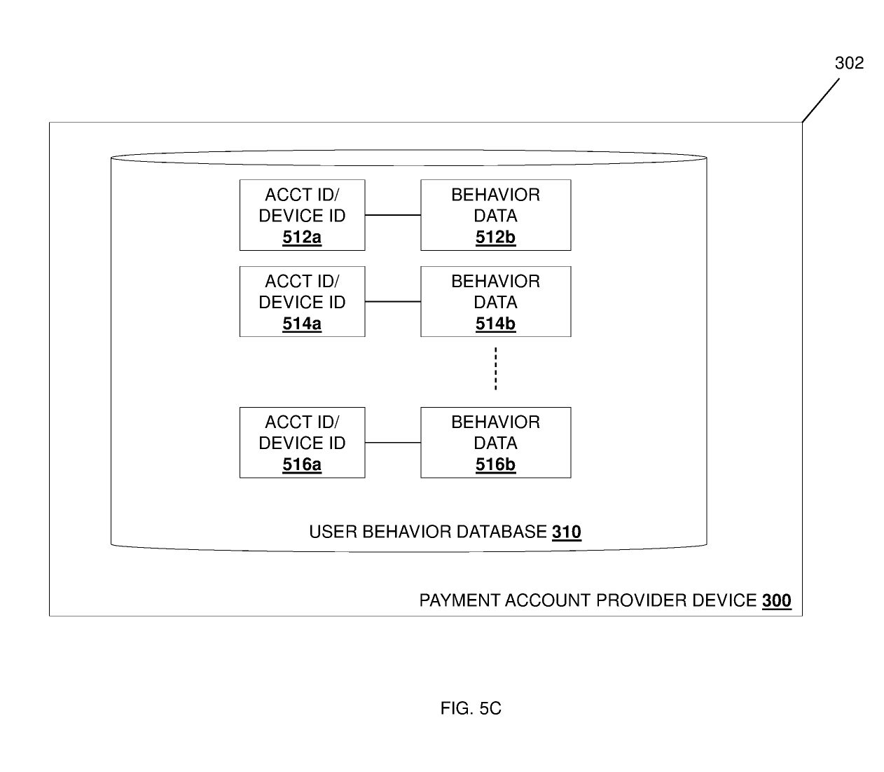

The method 100 then proceeds to decision block 114 where the account provider device determines that the user device application history information only includes a single transaction within a maximum time period, and subsequently determines whether that single transaction resulted in a loss. In an embodiment, at decision block 114, the transaction engine 304 in the account provider device 300 may access the user transaction database 306 and determine that the user device application history information includes only a single transaction that was performed via one of the first merchant applications on the user device 200 using the account. With reference to FIG. 5A, the user transaction loss database 306 is illustrated that includes account identifier/unique hardware identifier combinations 500a, 502a, and 504a that are each associated with respective transactions 500b, 502b, and 504b that are each linked to a respective transaction result 500c, 502c, and 504c. As such, the transaction engine 304 in the account provider device 300 may utilize the account identifier and unique device hardware identifier retrieved from the second merchant application transaction (e.g., account identifier/device identifier 500a), and identify that only a single transaction (e.g., transaction 500b) is associated with that payment account identifier and unique device hardware identifier (e.g., the account identifier/device identifiers 502a and 504a are associated with other payment account/user devices utilized by other users), and the retrieve its associated transaction result (e.g., transaction result 500c).

In response determining that the user device application history information includes only a single transaction that was performed via one of the first merchant applications on the user device 200 using the account, the transaction engine 304 in the account provider device 300 may determine whether that single transaction has occurred within a maximum time period. For example, the transaction engine 304 in the account provider device 300 may review the single transaction that was identified (e.g., transaction 500b), and determine a time when that transaction occurred and whether that time is less than the maximum time period. In the illustrated embodiment, the maximum time period is 1 month, although one of skill in the art in possession of the present disclosure will recognize that other maximum time periods will fall within the scope of the present disclosure as well. While not illustrated, if it is determined that the single transaction occurred outside of the maximum time period, the method may proceed to block 112 where the account provider device declines the second merchant application transaction, discussed in further detail below.

In an embodiment, the transaction engine 304 in the account provider device 300 may then analyze the transaction result (e.g., transaction result 500c) for the single transaction that was identified (e.g., transaction 500b), and determine whether that transaction resulted in a loss. For example, a loss resulting from a transaction may include a loss resulting from non-sufficient funds in a customers bank account, or a loss resulting from unauthorized use of the customer's account, a loss resulting from stolen financial information, a merchandize loss, and/or other losses known in the art.

If, at decision block 114, the account provider device determines that the user device application history information only includes a single transaction within a maximum time period and that single transaction did not result in a loss, the method 100 proceeds to block 110 where the account provider device processes the second merchant application transaction substantially as discussed above. Continuing one of the examples discussed above, the transaction engine 304 in the account provider device 300 may determine that the single transaction that may have been performed via any one of the service provider application 212, the rideshare application 214, or the coffee shop application 216 using the account, occurred within the last month and did not result in a loss and, in response, approve the second merchant payment transaction to enable the account as a payment option with the hotel application 400. Continuing another of the examples discussed above, the transaction engine 304 in the account provider device 300 may determine that the single transaction that may have been performed via any one of the service provider application 212 and the rideshare application 214 using the account, occurred within the last month and did not result in a loss and, in response, approve the transaction via the coffee shop application 216 using the account. As such, in some embodiments, a determination that the user device application history information only includes a single transaction within a maximum time period and that single transaction did not result in a loss may “white list”, or automatically allow for the approval of, subsequent merchant application transactions that include the unique device hardware identifier for the user device 200 and the payment account identifier for the payment account.

If, at decision block 114, the account provider device determines that the user device application history information include a plurality of transactions, the method 100 proceeds to decision block 116 where the account provider device determines whether any of the plurality of transaction resulted in a loss. In an embodiment, at decision block 116, the transaction engine 304 in the account provider device 300 may access the user transaction database 306 and determine that the user device application history information includes a plurality of transactions that were performed via any or all of the first merchant applications on the user device 200 using the account. With reference to FIG. 5A, the transaction engine 304 in the account provider device 300 may utilize the account identifier and unique device hardware identifier retrieved from the second merchant application transaction, and identify a plurality of transactions (e.g., any plurality of the transactions 500a-500c) and their associated transaction results (e.g., transaction result 500a-c).

In response to identifying the plurality of transactions, the transaction engine 304 in the account provider device 300 may then analyze the transaction results (e.g., any of the transaction results 500a-500c) for the plurality of transactions that were identified (e.g., any of the transactions 500a-500c), and determine whether any of those transactions resulted in a loss.

If, at decision block 116, the account provider device 300 determines that the none of the plurality of transactions included in the user device application history information resulted in a loss, the method 100 proceeds to block 110 where the account provider device processes the second merchant application transaction substantially as discussed above. Continuing one of the examples discussed above, the transaction engine 304 in the account provider device 300 may determine that none of the plurality of transactions performed via any or all of the service provider application 212, the rideshare application 214, and the coffee shop application 216 using the account resulted in a loss and, in response, approve the second merchant transaction to enable the account as a payment option with the hotel application 400. Continuing another of the examples discussed above, the transaction engine 304 in the account provider device 300 may determine that none of the plurality of transactions performed via any or all of the service provider application 212 and the rideshare application 214 using the account resulted in a loss and, in response, approve the transaction via the coffee shop application 216 using the account. As such, in some embodiments, a determination that the user device application history information includes a plurality of transactions, none of which resulted in a loss, may “white list”, or automatically allow for the approval of, subsequent merchant application transactions that include the unique device hardware identifier for the user device 200 and the payment account identifier for the payment account.

If, at decision block 116, the account provider device determines that any of the plurality of transactions included in the user device application history information resulted in a loss, the method 100 proceeds to decision block 118 where the account provider device determines whether the user device application history information indicates that an authentication flow was previously completed for any of the first merchant applications. In an embodiment, at decision block 118, the transaction engine 304 in the account provider device 300 may access the user authentication flow database 308 and whether the user device application history information indicates whether an authentication flow was performed for any of the first merchant applications on the user device 200. With reference to FIG. 5B, the user authentication flow database 308 is illustrated that includes payment account identifier/unique hardware identifier combinations 506a, 508a, and 510a that are each associated with respective user authentication flows 506b, 508b, and 510b that are each linked to a respective user authentication flow result 506c, 508c, and 510c. As such, the transaction engine 304 in the account provider device 300 may utilize the account identifier and unique device hardware identifier retrieved from the second merchant application transaction, and identify whether an authentication flow has been completed by the user for any of the first merchant applications included on the user device 200.

As would be understood by one of skill in the art in possession of the present disclosure, an authentication flow may include a user attempting a transaction from a new device, which alerts the risk system and triggers a “step up” authentication with the users trusted device. The user may receive a code that is sent to their trusted device in the form of a 2 way Short Message Server (SMS) or Interactive Voice Response (IVR). When the user then enters the code correctly, they have verified the step-up authentication and can freely transact.

If, at decision block 118, the account provider device determines that the user device application history information indicates that an authentication flow was previously completed for any of the first merchant applications, the method 100 proceeds to block 110 where the account provider device processes the second merchant application transaction substantially as discussed above. Continuing one of the examples discussed above, the transaction engine 304 in the account provider device 300 may determine that an authentication flow was completed for any or all of the service provider application 212, the rideshare application 214, and the coffee shop application 216 (e.g., in order to enable the payment account as a payment option for that application and/or utilize the account to perform a payment transaction via that application) and, in response, approve the second merchant payment transaction to enable the account as a payment option with the hotel application 400. Continuing another of the examples discussed above, the transaction engine 304 in the account provider device 300 may determine that an authentication flow was completed any or all of the service provider application 212 and the rideshare application 214 (e.g., in order to enable the payment account as a payment option for that application and/or utilize the account to perform a payment transaction via that application) and, in response, approve the second merchant payment transaction to approve the transaction to perform a transaction via the coffee shop application 216 using the account. As such, in some embodiments, a determination that the user device application history information identifies that an authentication flow was completed for any of the first merchant applications on the user device 200 may “white list”, or automatically allow for the approval of, subsequent merchant application transactions that include the unique device hardware identifier for the user device 200 and the payment account identifier for the payment account.

If, at decision block 118, the account provider device determines that the user device application history information indicates that no authentication flow has been previously completed for any of the first merchant applications, the method 100 proceeds to decision block 120 where the account provider device determines whether the user device application history information includes behavior information that allows for approval of the second merchant application transaction. In an embodiment, at decision block 120, the transaction engine 304 in the account provider device 300 may access the user behavior database 310 and determine whether the user device application history information includes behavior information that allows the second merchant application transaction to be approved. With reference to FIG. 5C, the user behavior database 310 is illustrated that includes account identifier/unique hardware identifier combinations 512a, 514a, and 516a that are each associated with respective user behavior data 512b, 514b, and 516b. As such, the transaction engine 304 in the account provider device 300 may utilize the account identifier and unique device hardware identifier retrieved from the second merchant application transaction, and identify behavior data that details the behaviors of the user in utilizing the first merchant applications included on the user device 200.

As would be understood by one of skill in the art in possession of the present disclosure, behavior data may include information identifying any use of the first merchant application that provides a level of trust in the use of the second application that is sufficient to allow that use to be trusted. As such, purchases without incident (e.g., without returns, failures to pay, etc.), good payment activity (payment on time, payment in full, etc.), and/or any other application usage behavior data that would be apparent to one of skill in the art may be utilized at decision block 118.

If, at decision block 118, the account provider device determines that the user device application history information indicates that the behavior data allows the second merchant application transaction to be approved, the method 100 proceeds to block 110 where the account provider device processes the second merchant application transaction substantially as discussed above. Continuing one of the examples discussed above, the transaction engine 304 in the account provider device 300 may determine that behavior data associated with the use of any or all of the service provider application 212, the rideshare application 214, and the coffee shop application 216 indicates that the second merchant application transaction to be approved and, in response, approve the second merchant transaction to enable the payment account as a payment option with the hotel application 400. Continuing another of the examples discussed above, the transaction engine 304 in the account provider device 300 may determine that behavior data associated with the use of the service provider application 212 and the rideshare application 214 indicates that the second merchant application transaction should be allowed and, in response, approve the second merchant transaction to approve the transaction to perform a transaction via the coffee shop application 216 using the account. As such, in some embodiment, a determination that the user device application history information includes behavior information that allows for approval of the second merchant application transaction may “white list”, or automatically allow for the approval of, subsequent merchant application transactions that include the unique device hardware identifier for the user device 200 and the payment account identifier for the payment account.

If, at decision block 120, the account provider device determines that the user device application history information does not includes behavior information that allows for approval of the second merchant application transaction, the method 100 proceeds to block 122 where the account provider device declines the second merchant application transaction. In an embodiment, at block 122, the transaction engine 304 in the account provider device 300 may operate to decline the second merchant application transaction to, for example, prevent the enablement of the account as a payment option with any of the first merchant applications (e.g., the hotel application 400 of FIG. 4A), or prevent the use of the account to perform a transaction via a first merchant application (e.g., the coffee shop application 214).

Thus, systems and methods for device-hardware-based trust of merchant applications have been described that utilize device hardware identifiers to approve merchant-application-based transactions that would otherwise be declined using conventional risk models. Those system and methods operate by receiving a current merchant application transaction from a user device that is generated by a second merchant application and, when the analysis of that current merchant application transaction indicates that a conventional risk model will result in a decline state for that current merchant application transaction, utilizing a device hardware identifier and an account identifier in that current merchant application transaction to access database(s) of user device application history information that details the use of first application(s) included on user device, which provides for an enhanced determination of whether to approve or decline that current merchant application transaction. Experimental embodiments indicate that the systems and methods described herein can reduce the false or incorrect declining of merchant application transactions by an appreciable margin, thus improving online/mobile merchant application transaction technology with respect to the use of accounts provided by third party payment account providers.

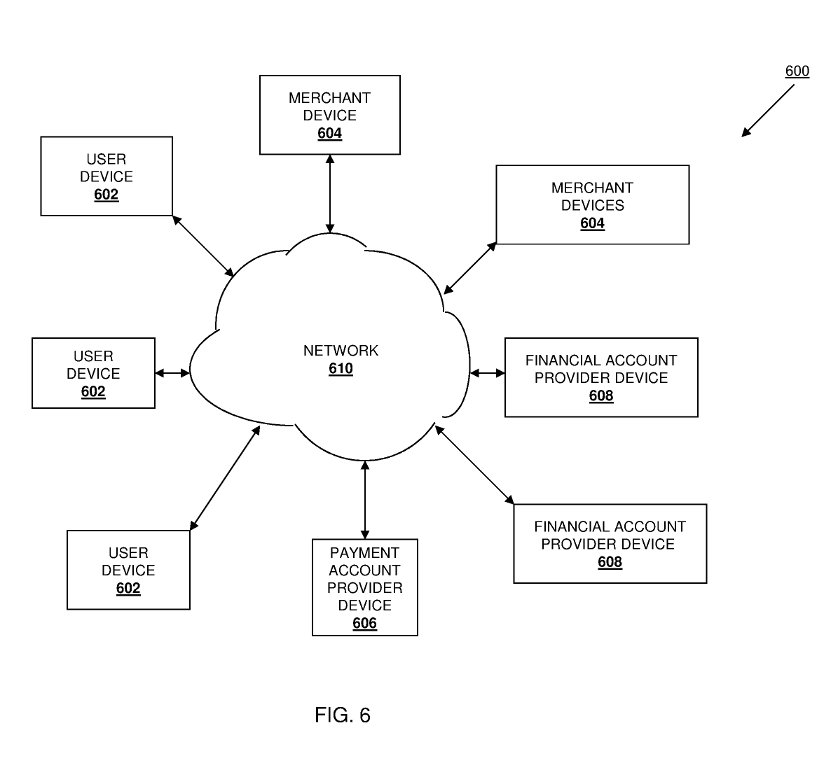

Referring now to FIG. 6, an embodiment of a network-based system 600 for implementing one or more processes described herein is illustrated. As shown, network-based system 600 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 6 may be deployed in other ways and that the operations performed and/or the services provided by such servers may be combined or separated for a given implementation and may be performed by a greater number or fewer number of servers. One or more servers may be operated and/or maintained by the same or different entities.

The embodiment of the networked system 600 illustrated in FIG. 6 includes a plurality of user devices 602, a plurality of merchant devices 604, an account provider device 606, and a plurality of account provider devices 608 in communication over a network 610. Any of the user devices 602 may be the user devices discussed above, and of the merchant devices 604 may be the merchant devices discussed above and may be operated by the merchant discussed above. The account provider device 606 may be the account provider devices discussed above and may be operated by a payment account provider such as, for example, PayPal Inc. of San Jose, Calif., United States. The account provider devices 608 may be the account provider devices discussed above and may be operated by the account providers discussed above such as, for example, credit card account providers, bank account providers, savings account providers, and a variety of other account providers known in the art.

The user devices 602, merchant devices 604, account provider device 606, and account provider devices 608 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 600, and/or accessible over the network 610.

The network 610 may be implemented as a single network or a combination of multiple networks. For example, in various embodiments, the network 610 may include the Internet and/or one or more intranets, landline networks, wireless networks, and/or other appropriate types of networks.

The user device 602 may be implemented using any appropriate combination of hardware and/or software configured for wired and/or wireless communication over network 610. For example, in one embodiment, the user device 602 may be implemented as a personal computer of a user in communication with the Internet. In other embodiments, the user device 602 may be a smart phone, personal digital assistant (PDA), laptop computer, and/or other types of computing devices.

The user device 602 may include one or more browser applications which may be used, for example, to provide a convenient interface to permit the payer to browse information available over the network 610. For example, in one embodiment, the browser application may be implemented as a web browser configured to view information available over the Internet.

The user device 602 may also include one or more toolbar applications which may be used, for example, to provide user-side processing for performing desired tasks in response to operations selected by the user. In one embodiment, the toolbar application may display a user interface in connection with the browser application.

The user device 602 may further include other applications as may be desired in particular embodiments to provide desired features to the user device 602. In particular, the other applications may include a payment application for payments assisted by a payment account provider through the account provider device 606. The other applications may also include security applications for implementing user-side security features, programmatic user applications for interfacing with appropriate application programming interfaces (APIs) over the network 610, or other types of applications. Email and/or text applications may also be included, which allow the user to send and receive emails and/or text messages through the network 610. The user device 602 includes one or more user and/or device identifiers which may be implemented, for example, as operating system registry entries, cookies associated with the browser application, identifiers associated with hardware of the user device 602, or other appropriate identifiers, such as a phone number. In one embodiment, the user identifier may be used by the account provider device 606 and/or account provider device 608 to associate the user with a particular account as further described herein.

The merchant device 604 may be maintained, for example, by a conventional or on-line merchant, conventional or digital goods seller, individual seller, and/or application developer offering various products and/or services in exchange for payment to be received conventionally or over the network 610. In this regard, the merchant device 604 may include a database identifying available products and/or services (e.g., collectively referred to as items) which may be made available for viewing and purchase by the user.

The merchant device 604 also includes a checkout application which may be configured to facilitate the purchase by the payer of items. The checkout application may be configured to accept payment information from the user through the user device 602, the account provider through the account provider device 608, and/or from the account provider through the payment account provider device 606 over the network 610.

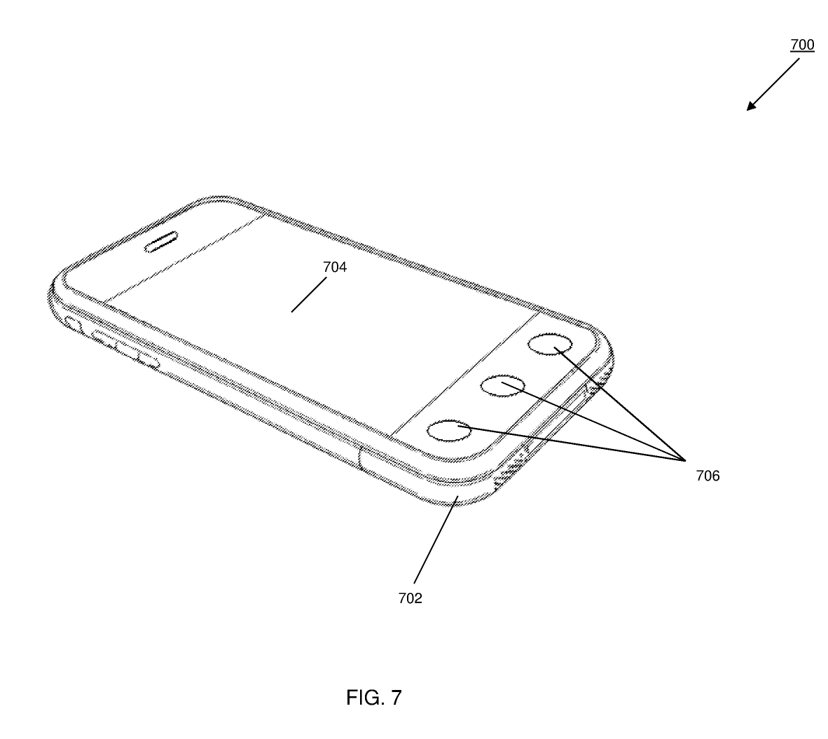

Referring now to FIG. 7, an embodiment of a user device 700 is illustrated. The user device 700 may be the user devices discussed above. The user device 700 includes a chassis 702 having a display 704 and an input device including the display 704 and a plurality of input buttons 706. One of skill in the art will recognize that the user device 700 is a portable or mobile phone including a touch screen input device and a plurality of input buttons that allow the functionality discussed above with reference to the method 100. However, a variety of other portable/mobile user devices and/or desktop user devices may be used in the method 100 without departing from the scope of the present disclosure.

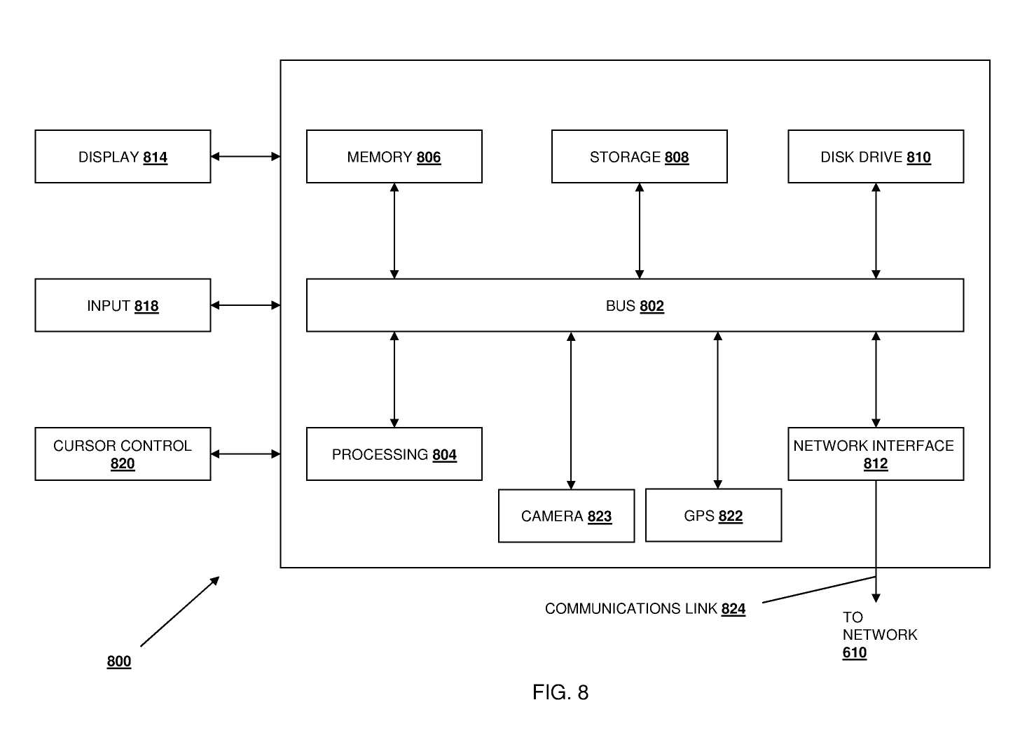

Referring now to FIG. 8, an embodiment of a computer system 800 suitable for implementing, for example, the user devices, the merchant devices, the payment account provider devices, and/or the financial account provider devices, is illustrated. It should be appreciated that other devices utilized by payer, payees, service providers, and account providers in the system discussed above may be implemented as the computer system 800 in a manner as follows.

In accordance with various embodiments of the present disclosure, computer system 800, such as a computer and/or a network server, includes a bus 802 or other communication mechanism for communicating information, which interconnects subsystems and components, such as a processing component 804 (e.g., processor, micro-controller, digital signal processor (DSP), etc.), a system memory component 806 (e.g., RAM), a static storage component 808 (e.g., ROM), a disk drive component 810 (e.g., magnetic or optical), a network interface component 812 (e.g., modem or Ethernet card), a display component 814 (e.g., CRT or LCD), an input component 818 (e.g., keyboard, keypad, or virtual keyboard), a cursor control component 820 (e.g., mouse, pointer, or trackball), and/or a location determination component 822 (e.g., a Global Positioning System (GPS) device as illustrated, a cell tower triangulation device, and/or a variety of other location determination devices known in the art.) In one implementation, the disk drive component 810 may comprise a database having one or more disk drive components.

In accordance with embodiments of the present disclosure, the computer system 800 performs specific operations by the processor 804 executing one or more sequences of instructions contained in the memory component 806, such as described herein with respect to the user devices, the merchant device(s), the payment account provider device, and/or the financial account provider device(s). Such instructions may be read into the system memory component 806 from another computer readable medium, such as the static storage component 808 or the disk drive component 810. In other embodiments, hard-wired circuitry may be used in place of or in combination with software instructions to implement the present disclosure.

Logic may be encoded in a computer readable medium, which may refer to any medium that participates in providing instructions to the processor 804 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 810, volatile media includes dynamic memory, such as the system memory component 806, and transmission media includes coaxial cables, copper wire, and fiber optics, including wires that comprise the bus 802. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the present disclosure, execution of instruction sequences to practice the present disclosure may be performed by the computer system 800. In various other embodiments of the present disclosure, a plurality of the computer systems 800 coupled by a communication link 824 to the network 610 (e.g., such as a LAN, WLAN, PTSN, and/or various other wired or wireless networks, including telecommunications, mobile, and cellular phone networks) may perform instruction sequences to practice the present disclosure in coordination with one another.

The computer system 800 may transmit and receive messages, data, information and instructions, including one or more programs (i.e., application code) through the communication link 824 and the network interface component 812. The network interface component 812 may include an antenna, either separate or integrated, to enable transmission and reception via the communication link 824. Received program code may be executed by processor 804 as received and/or stored in disk drive component 810 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on payees and payers; however, a payer or consumer can pay, or otherwise interact with any type of recipient, including charities and individuals. The payment does not have to involve a purchase, but may be a loan, a charitable contribution, a gift, etc. Thus, payee as used herein can also include charities, individuals, and any other entity or person receiving a payment from a payer. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A device-hardware-based trusted application system, comprising:
at least one database storing user device application history information that details the use of a first application included on user device, wherein the user device application history is stored in association with a combination of:
a user device hardware identifier that is unique to at least some hardware in the user device; and
a user account identifier that is unique to a user account utilized with the first application;
a non-transitory memory; and
one or more hardware processors coupled to the non-transitory memory and the at least one database, wherein the one or more hardware processors are configured to read instructions from the non-transitory memory to cause the system to perform operations comprising:
receiving, through a network from the user device, a second merchant application transaction that is associated with a second merchant application;
analyzing the second merchant application transaction using a first risk model to determine that the second merchant application transaction should be declined;
retrieving, from the second merchant application transaction in response to determining that the second merchant application transaction should be declined using the first risk model, the first user device hardware identifier and the user account identifier;
accessing, using the first user device hardware identifier and the user account identifier, the at least one database to retrieve the user device application history information; and
approving, based on the details of the use of the first application included in the user device application history information, the second merchant application transaction.

2. The system of claim 1, wherein the second merchant application transaction includes a request to add the user account as a payment option with the second merchant application.

3. The system of claim 1, wherein the second merchant application transaction includes a request to perform a transaction in the second merchant application using the user account.

4. The system of claim 1, wherein the approving the second merchant application transaction based on the details of the use of the first application included in the user device application history information includes:
determining a number of first application transactions included in the user device application history information, wherein:
in response to determining the user device application history information includes a single first application transaction associated with the first application:
determining that the single first application transaction was performed within a maximum time period and did not result in a loss and, in response, approving the second merchant application transaction;
in response to determining that user device application history information includes a plurality of first application transactions associated with the first application:
determining that none of the plurality of first application transactions resulted in a loss and, in response, approving the second merchant application transaction.

5. The system of claim 1, wherein the approving the second merchant application transaction based on the details of the use of the first application included in the user device application history information includes:
determining that the user device application history information identifies that an authentication flow has previously been completed with the first application and, in response, approving the second merchant application transaction.

6. The system of claim 1, wherein the approving the second merchant application transaction based on the details of the use of the first application included in the user device application history information includes:
analyzing behavior information included in the user device application history information and associated with the use of the first application and, in response, approving the second merchant application transaction.

7. A method for device-hardware-based trusted application transactions, comprising:
processing, by an account provider device, a second merchant application transaction that was generated by a user device and that is associated with a second merchant application;
analyzing, by the account provider device, the second merchant application transaction using a first risk model to determine a decline state for the second merchant application transaction;
identifying, by the account provider device in the second merchant application transaction in response to identifying the decline state for the second merchant application transaction according to the analysis using the first risk model, a first user device hardware identifier and a user account identifier;
retrieving, by the account provider device from at least one database using a combination of the first user device hardware identifier and the user account identifier, user device application history information that includes information associated with the use of a first application included on user device; and
determining, by the account provider device based on the details of the use of the first application included in the user device application history information, an approve state for the second merchant application transaction that overrides the decline state.

8. The method of claim 7, wherein the second merchant application transaction includes instructions to add the user account as a payment option with the second merchant application.

9. The method of claim 7, wherein the second merchant application transaction includes instructions to perform a transaction in the second merchant application using the user account.

10. The method of claim 7, wherein the determining the approve state for the second merchant application transaction based on the details of the use of the first application included in the user device application history information includes:
determining, by the account provider device, the user device application history information includes a single first application transaction associated with the first application; and
determining, by the account provider device, that the single first application transaction was performed within a maximum time period and did not result in a loss and, in response, determining the approve state for the second merchant application transaction.

11. The method of claim 7, wherein the determining the approve state for the second merchant application transaction based on the details of the use of the first application included in the user device application history information includes:
identifying, by the account provide device, that user device application history information includes a plurality of first application transactions associated with the first application; and
determining, by the account provider device, that none of the plurality of first application transactions resulted in a loss and, in response, determining the approve state for the second merchant application transaction.

12. The method of claim 7, wherein the determining the approve state for the second merchant application transaction based on the details of the use of the first application included in the user device application history information includes:
identifying, by the account provider device using the user device application history information, that an authentication flow has previously been completed with the first application and, in response, determining the approve state for the second merchant application transaction.

13. The method of claim 7, wherein the determining the approve state for the second merchant application transaction based on the details of the use of the first application included in the user device application history information includes:
analyzing, by the account provide device, behavior information included in the user device application history information and associated with the use of the first application and, in response, determining the approve state for the second merchant application transaction.

14. A non-transitory machine-readable medium having stored thereon machine-readable instructions executable to cause a machine to perform operations comprising:
identifying, through a network, a second merchant application transaction that is generated by a user device and that is associated with a second merchant application;
using a first risk model to analyze the second merchant application transaction and determine that the second merchant application transaction should be declined;
accessing, in the second merchant application transaction in response to determining that the second merchant application transaction should be declined using the first risk model, a first user device hardware identifier and a user account identifier;
utilizing a combination of the first user device hardware identifier and the user account identifier and at least one database to retrieve user device application history information that details the use of a first application included on user device; and
approving, based on the details of the use of the first application included in the user device application history information, the second merchant application transaction.

15. The non-transitory machine-readable medium of claim 14, wherein the second merchant application transaction includes a request to add the user account as a payment option with the second merchant application.

16. The non-transitory machine-readable medium of claim 14, wherein the second merchant application transaction includes a request to perform a transaction in the second merchant application using the user account.

17. The non-transitory machine-readable medium of claim 14, wherein the approving the second merchant application transaction based on the details of the use of the first application included in the user device application history information includes:
determining the user device application history information includes a single first application transaction associated with the first application; and
determining that the single first application transaction was performed within a maximum time period and did not result in a loss and, in response, approving the second merchant application transaction.

18. The non-transitory machine-readable medium of claim 14, wherein the approving the second merchant application transaction based on the details of the use of the first application included in the user device application history information includes:
determining that user device application history information includes a plurality of first application transactions associated with the first application; and
determining that none of the plurality of first application transactions resulted in a loss and, in response, approving the second merchant application transaction.

19. The non-transitory machine-readable medium of claim 14, wherein the approving the second merchant application transaction based on the details of the use of the first application included in the user device application history information includes:
determining that the user device application history information identifies that an authentication flow has previously been completed with the first application and, in response, approving the second merchant application transaction.

20. The non-transitory machine-readable medium of claim 14, wherein the approving the second merchant application transaction based on the details of the use of the first application included in the user device application history information includes:
analyzing behavior information included in the user device application history information and associated with the use of the first application and, in response, approving the second merchant application transaction.
